(19) United States
(12) Patent Application Publication
(10) Pub. No.: US 2007/0245609 A1
(43) Pub. Date: Oct. 25, 2007

(54) Hand-held writable paddle

(76) Inventor: Scott Becker, Milwaukee, WI (US)

Correspondence Address: RYAN KROMHOLZ & MANION, S.C., POST OFFICE BOX 26618, MILWAUKEE, WI, 53226, US

(21) Appl. No.: 11/410,381

(22) Filed: Apr. 25, 2006

(51) Int. Cl. G09F 21/02

(52) U.S. Cl. 40/586

(57) ABSTRACT

A hand-held sign having a generally planar sign member. The planar sign member has first and second sides having erasable writing surfaces. The sign member has a generally rectangular perimeter. A handle extends downwardly from the perimeter.

### BACKGROUND OF THE INVENTION

The present invention relates to hand-held signs and, more specifically, hand-held signs that can be written upon and are erasable.

The use of signs to convey messages and information is widely known. Many currently designed signs are focused on developing and advancing technology, such as electronic signs and scrolling signs and signboards, or digitally enhanced signs. While such signs provide good visual effects, they generally are not useful in situations that require an immediate message displayed or where it is not feasible because of the lack of available power needed for the signs. As an example, such signs would not be feasible for use at most sporting events or when driving or when stranded on a highway.

Signs have been contemplated that are simple to use. For instance, Buckley, WO 01/71700, “Hand-Held Novelty Sign”, describes a sign in the shape of a cartoon or comic strip bubble. While a user could write a quick message on the sign, it is not the most efficiently used sign, and does not necessarily completely utilize the writing area on the sign. Normally, people write from left to write, with each of the written lines being approximately the same length. Because of the contours of Buckley that are formed by shaping the writing surface as that of a cartoon bubble, there is much lost area on the writing surface and, the user may succumb to trying to cram words into areas where words do not fit and distorting the message. This can frustrate the user and, also, lead to an unintelligible message. Clarity of the message is especially important when a person would not have much time to focus on the message, such as would be the case when driving or at an emergency along a highway. Because Buckley is designed for use as a novelty item, it is not the most useful item for conveying urgent messages with high clarity.

Furthermore, Buckley does not offer or suggest a storage area for a writing utensil in conjunction with the sign, which prevents the sign from being truly advantageous when needed in an emergency, such as at a roadside accident or driving down the road. At a sporting event or the like, having an easily accessible writing device is preferred so that the user does not have to search around for a writing device, and there is less of a chance to lose the writing device.

When driving down the road, if a driver must communicate with another person outside of the vehicle, the driver cannot take time to navigate a cartoon-bubble shaped sign to make sure the message is properly written on the sign, and a driver does not have time to search for a writing utensil to use on the sign.

Thus, an efficient, simple sign is needed that provides an erasable writing surface that is easily usable in situations where not much thought or focus can be given for sizing up a writing surface for legibly writing the message on the sign. The sign should provide a writing surface to accommodate the normal writing patterns of people and should contemplate the necessity of having accessible writing materials in conjunction with the sign.

### SUMMARY OF THE INVENTION

The present invention comprises a hand-held sign having a generally planar sign member. The sign member has a first side having an erasable writing surface, and a second side having an erasable writing surface. The sign member has a generally rectangular perimeter. A handle extends downwardly from the perimeter of the sign for a person to grab. The sign may further include at least one detachable writing utensil, and may include at least one detachable eraser.

### BRIEF DESCRIPTION OF THE DRAWINGS

FIG. 1 is an exploded perspective view of a sign in accordance with the present invention.

FIG. 2 is a front elevated plane view of the sign of FIG. 1 without a message.

FIG. 3 is a rear elevated plane view of the sign of FIG. 1.

FIG. 4 is a perspective view of the sign of FIG. 1 having the message shown in FIG. 1 being erased.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

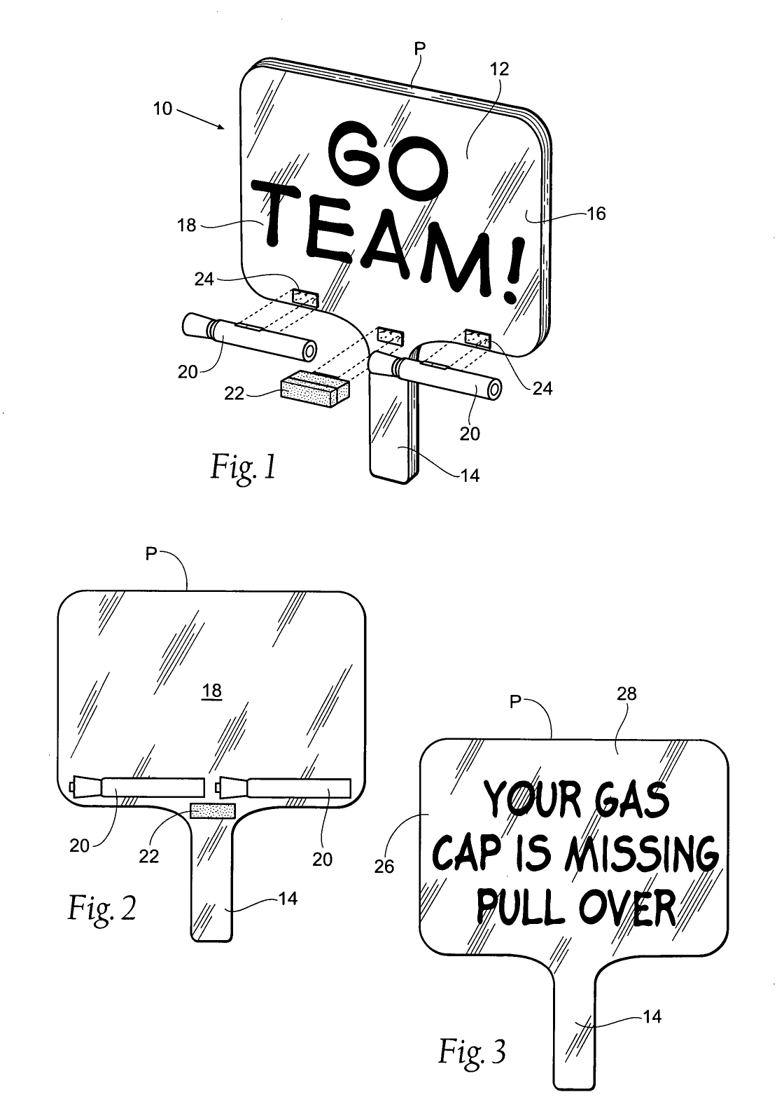

FIG. 1 shows a hand-held sign 10 in accordance with the present invention. The hand held sign 10 generally comprises a sign member 12 and a handle 14. The sign member 12 has a generally rectangular-shaped perimeter P. A first side 16 of the sign member 12 has a writing surface 18. The generally rectangular-shaped perimeter P of the sign member 12 is advantageous over the prior art by allowing the writing surface 18 and a message to conform and be fashioned towards the normal writing pattern of a person, which is across from left to write. The writing surface 18 allows a person to write normally on the surface 18 without having to navigate where the perimeter ends, as may have to be done when using a curved or balloon-shaped writing surface. A pair of writing utensils 20 and an eraser 22 are shown. There may be more or fewer writing utensils 20 and/or erasers 22 than shown and still fall within the scope of the present invention. Attachment means 24 are used for releasably attaching the writing utensils 20 and the eraser 22 to the sign member 10. The attachment means 24 are preferably a hook and loop material, such as VELCRO®, having either the hook or loop material adhered to the sign 10 and the other material attached to the writing utensils 20 and the eraser 22. However, other attachment means 24, such as a string or cord connected to both the sign and the writing utensil or eraser, could be used and still fall within the scope of the present invention.

FIG. 2 shows the sign 10 having a clean first writing surface 18. The writing utensils 20 and the eraser 22 are attached to the sign, preferably within the area of the perimeter P of the sign member 12, but not as to interfered with the writing surface 18. While this arrangement is not necessary, it provides a compact and aesthetically pleasing sign 10 that does not require the user to search for writing instruments to use on the sign at inconvenient times, such as when driving down the road. As shown, the handle 14 and the sign member 12 are preferably integrally formed, with the handle 14 being centrally located with respect to the sign member 12 on the lower side of the perimeter P of the sign member 12. The handle 14 is also preferably made of the same material as the first writing surface 18, and preferably the same thickness as the sign member 12.

FIG. 3 shows a rear planar view of the sign 12. A second side 26 of the sign 12 is shown having a second writing surface 28. The second writing surface 28 is identical to the first writing surface 18, having the same rectangular shaped perimeter P. This carries all the advantages of the first writing surface 18. Furthermore, because the handle 14 is preferably centrally located with respect to the writing surfaces 18 and 28, it is easy for a person to properly align their writing on either side of the sign 10. The second writing surface 28 is a symmetrical, mirror image of the first writing surface 18. Therefore, if a user is writing on one surface and needs to turn over the sign to complete the message but cannot give his or her full attention to the writing process, the present invention allows the user to efficiently orientate the message on the second side, which was not easily done with the prior art. Thus, the sign 10 provides further advantages and safety precautions not previously seen for handheld signs. Also, the sign 10 could have means for attaching the eraser 22 and/or the writing utensils 20 to the second side 26, but it is not necessary.

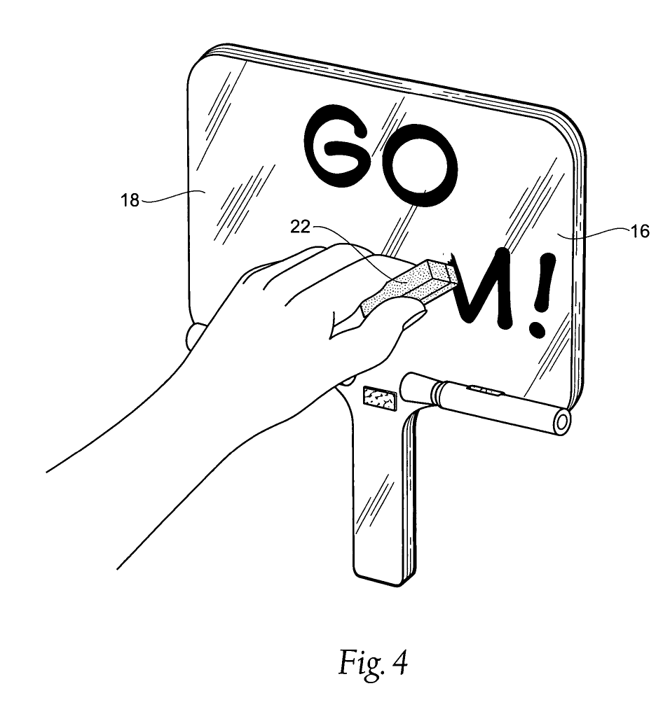

FIG. 4 demonstrates a message being erased from the sign 10. A person will grab the eraser 22 and remove the message from the writing surface 18. Preferably, the writing surface 18 is a dry erase surface, as is the second writing surface 28, and the eraser 22 is a dry erase eraser. Thus, a person can easily remove and change a written message as necessary. The body of the sign 10 can be made of any material, but a lightweight material, such as a lightweight plastic or cardboard material, is preferred so that the sign 10 is easily moved and transported.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A hand-held sign comprising:
a generally planar sign member comprising:
a first side having an erasable writing surface;
a second side having a second erasable writing surface; and
a generally rectangular perimeter; and
a handle extending downwardly from said perimeter.

2. The hand-held sign according to claim 1 further comprising:
at least one erasable writing utensil; and
means for removably attaching said writing utensil to said sign.

3. The hand-held sign according to claim 2 wherein said means for attaching said writing utensil comprises a hook and loop material.

4. The hand-held sign according to claim 2 wherein said means for attaching said writing utensil is located on said sign member.

5. The hand-held sign according to claim 2 further comprising:
at least one eraser; and
means for removably attaching said eraser to said sign.

6. The hand-held sign according to claim 5 wherein said means for attaching said eraser comprises a hook and loop material.

7. The hand-held sign according to claim 6 wherein said means for attaching said eraser is located on said sign member.

8. The hand-held sign according to claim 1 wherein said handle is integrally formed with said sign member.

9. The hand-held sign according to claim 8 wherein said handle comprises an erasable writing surface.

10. The hand-held sign according to claim 1 wherein said erasable writing surfaces are dry-erase surfaces.

11. The hand-held sign according to claim 1 wherein said handle extends centrally from the bottom side of said perimeter of said sign member.

12. The hand-held sign according to claim 11 wherein said first and said second writing surfaces are symmetrical, mirror images of one another.

13. A hand-held sign for providing an urgent message in a quick and efficient manner, said sign comprising:
a generally planar sign member comprising:
a first side having a dry erase, erasable writing surface;
a second side having a second dry erase, erasable writing surface, said first and said second writing surfaces being symmetrical, mirror images of one another; and
a generally rectangular perimeter;
a handle extending downwardly from said perimeter, said handle extending downwardly and centrally from the bottom side of said perimeter of said sign member;
at least one dry erase writing utensil;
at least one dry erase eraser; and
means for removably attaching said writing utensil and said eraser to said sign.

14. The hand-held sign according to claim 13 wherein said means for attaching said writing utensil comprises a hook and loop material.
